(19) United States
(12) Patent Application Publication
(10) Pub. No.: US 2004/0229663 A1
(43) Pub. Date: Nov. 18, 2004

(54) Mobile electronic device with tactile keyboard

(76) Inventors: Joseph P. R. Tosey, North Vancouver (CA); Eric Lee, Surrey (CA)

Correspondence Address: Robert E. Krebs, Thelen Reid & Priest LLP, P.O. Box 640640, San Jose, CA, 95164-0640, US

(21) Appl. No.: 10/439,722

(22) Filed: May 16, 2003

(51) Int. Cl. H04M 1/10

(52) U.S. Cl. 455/575.1

(57) ABSTRACT

An electronic device that has a lower portion that unfolds to reveal an extendable keyboard. When the keyboard is folded closed, a number pad is visible and the device looks similar to a traditional portable or cellular telephone. The device can be used as a personal digital assistant, a cellular telephone, a cordless telephone or as the handset of a traditional wire line telephone. The fold-out keyboard of the electronic device can be used for easy entry of text data while a communication channel is active. The keys comprising the keyboard include tactile indicia to facilitate typing.

### BACKGROUND OF THE INVENTION

The present invention relates generally to the field of mobile electronic communication devices such as personal digital assistants and cellular telephones.

Today there is a wide variety of mobile electronic devices such as personal digital assistants and cellular telephones. These mobile devices must be small and therefore their keys which enable a user to input information must be small.

A cellular telephone is designed to give the user maximum freedom of movement while using a telephone. A cellular telephone uses radio signals to communicate between the “cell phone” and a base station, via an antenna. The area served by such mobile electronic communication devices is divided into cells something like a honeycomb, and an antenna is placed within each cell and connected by telephone lines to one exchange devoted to cellular-telephone calls. This exchange connects cellular mobile electronic communication devices to one another and transfers the call to a regular exchange, public switched telephone network, if the call is between a cellular telephone and a non-cellular telephone. The special cellular exchange, through computer control, selects the antenna closest to the telephone when service is requested. As the telephone roams, the exchange automatically determines when to change the serving cell based on the power of the radio signal received simultaneously at adjacent sites. This change occurs without interrupting conversation. Practical power considerations limit the distance between the telephone and the nearest cellular antenna, and since cellular phones use radio signals, it is possible for unauthorized people to access communications carried out over cellular phones. One of the reasons why digital cell phones have gained in popularity, besides being able to access the Internet, is because their radio signals are harder to intercept and decode.

Analog transmission, in which speech or data is converted directly into a varying electrical current, is suitable for local calls. But once the call involves any significant distance, the necessary amplification of the analog signal can add so much noise that the received signal becomes unintelligible. For long-distance calls, the signal is digitized, or converted to a series of pulses that encodes the information. When an analog electrical signal is digitized, samples of the signal's strength are taken at regular intervals, usually about 8000 samples per second. Each sample is converted into a binary form, a number made up of a series of Is and Os. This number is easily and swiftly passed through the switching system. Digital transmission systems are much less subject to interfering noise than are analog systems. The digitized signal can then be passed through a digital-to-analog converter (DAC) at a point close to the receiving party, and converted to a form that the ear cannot distinguish from the original signal. There are several ways a digital or analog signal may be transmitted, including coaxial and fiber-optic cables and microwave and longwave radio signals sent along the ground or bounced off satellites in orbit around the earth. A coaxial wire, like the wire between a videocassette recorder (VCR) and a television set, is an efficient transmission system. A coaxial wire has a conducting tube surrounding another conductor. A coaxial cable contains several coaxial wires in a common outer covering. The important benefit of a coaxial cable over a cable composed of simple wires is that the coaxial cable is more efficient at carrying very high frequency currents. This is important because in providing transmission over long distances, many telephone conversations are combined using frequency-modulation (FM) techniques similar to the combining of many channels in the television system. The combined signal containing hundreds of individual telephone conversations is sent over one pair of wires in a coaxial cable, so the signal has to be very clear.

Fiber optic cable offer another telephone-transmission method that uses bundles of optical fibers, long strands of specially made glass encased in a protective coating. Optical fibers transmit energy in the form of light pulses. The technology is similar to that of the coaxial cable, except that the optical fibers can handle tens of thousands of conversations simultaneously. Another approach to long-distance transmission is the use of radio. Before coaxial cables were invented, very powerful longwave (low frequency) radio stations were used for intercontinental calls. Microwave radio uses very high frequency radio waves and has the ability to handle a large number of simultaneous conversations over the same microwave link. Because cable does not have to be installed between microwave towers, this system is usually cheaper than coaxial cable. On land, the coaxial-cable systems are often supplemented with microwave-radio systems. The technology of microwave radio is carried one step further by the use of communications satellites. Most communications satellites are in geosynchronous orbit—that is, they orbit the earth once a day over the equator, so the satellite is always above the same place on the earth's surface. That way, only a single satellite is needed for continuous service between two points on the surface, provided both points can be seen from the satellite. A combination of microwave, coaxial-cable, optical-fiber, and satellite paths now link the major cities of the world. The capacity of each type of system depends on its age and the territory covered, but capacities generally fall into the following ranges: Frequency modulation over a simple pair of wires like the earliest telephone lines yields tens of circuits (a circuit can transmit one telephone conversation) per pair; coaxial cable yields hundreds of circuits per pair of conductors, and thousands per cable; microwave and satellite transmissions yield thousands of circuits per link; and optical fiber has the potential for tens of thousands of circuits per fiber.

Computer-controlled exchange switches make it possible to offer a variety of extra services to both the residential and the business customer. Some services to which users may subscribe at extra cost are call waiting, in which a second incoming call, instead of receiving a busy signal, hears normal ringing while the subscriber hears a beep superimposed on the conversation in progress; and three-way calling, in which a second outgoing call may be placed while one is already in progress so that three subscribers can then talk to each other. Other services available to users are: caller ID, in which the calling party's number is displayed to the receiver on special equipment before the call is answered; and repeat dialing, in which a called number, if busy, will be automatically redialed for a certain amount of time. Of course users have the ability to block their name and phone from being displayed on a caller ID display. Another popular service is voice mail. While traditional answering machines cannot take a message if a caller is already on the line, voice mail creates a second virtual line. While a caller is talking to one party, a second incoming call is greeted with a message asking the second party to leave a message. The user will then be notified of the waiting message.

Unified messaging and the arrival of mobile Internet services means Short Message Service (SMS), a mobile messaging service, will soon become the primary alert mechanism for users to check and pick up their e-mail, fax or voice messages. Enhanced Message Service (EMS), Instant Messaging (ICQ), and Multimedia Message Service (MMS) message protocols can be expected to grow in popularity in the future. The rapidly growing availability of WAP (Wireless Application Protocol) has enabled handsets to enhance the customer experience of reading and sending more messages. The arrival of the GSM (Global System for Mobile communications) family's next phase of evolution in the form of GPRS (General Packet Radio Services) will ensure faster speeds and boost the variety of mobile services available significantly. Mobile banking, M-Commerce, and customer service applications are also bolstering SMS traffic. The arrival of more advanced data services will yet again increase demand. During the First (1 G) and Second (2 G) Generations of mobile communications different regions of the world pursued different mobile phone standards. Europe pursued NMT and TACS for analog and GSM for digital. North America pursued AMPS for analog and a mix of TDMA, CDMA and GSM for digital. The Third Generation (3 G), based on CDMA technology, will bring these incompatible standards together and allow convergence toward a common standard for mobile multimedia.

It is an object of the present invention to enrich the user's experience of the mobile Internet by facilitating efficient text entry. As mobile phones, personal digital assistants and computers converge towards unified handheld communication and computing devices, text messaging is becoming one of many ways in which text entry on handheld devices will be employed. Text entry is an integral part of the way users interact with computers in general and the Internet in particular. Simple text entry is required to query search engines, to find contacts in a phone list, to send email or instant messages and to enter commands. The inadequacy of currently used methods for entering text is the major obstacle inhibiting the growth of a wireless web and other applications, such as, Microsoft's Pocket Word and Pocket Excel. A numeric keypad such as that found in most cellular devices is poor device for entering strings of text data. For example, to enter certain letters a user must strike a key three times. A QWERTY-style keyboard on a mobile device is needed to provide an easy to use and familiar text entry solution. Such a device will help the mobile Internet achieve its full commercial potential for communication of all forms including voice, text and multi-media.

Currently researchers are studying keyboard design, and the following reference papers are examples. MacKenzie, S. I., Soukoreff, R. W., “Text entry for mobile computing: Models and Methods, Theory and Practice”, (in press) Human-Computer Interaction. Source: http://www.yorku.ca/mack/hci3.html. MacKenzie, S. I., Soukoreff, R. W., “A model of two-thumb text entry”, Proceedings of Graphics Interface 2002, pp 117-124. Toronto: Canadian Information Processing Society. Source http://www.yorku.ca/mack/gi2002.html.

Current devices for entering text on a mobile electronic device do not facilitate the use of the keys by the user. In many cases the keys are configured in less than optimum ways, with regard to position, location or key shape. It is an object of the present invention to overcome these problems.

An important feature of the present hand held electrical device is that data input through an extendable keyboard works in conjunction with launching and using wireless applications such as SMS, E-mail and web surfing, as well as an enter-then-act device user interaction paradigm. An enter-then-act device is disclosed in U.S. patent application titled “Enter-Then-Act Input Handling” Ser. No. 10/165,598, filed Jun. 7, 2002, which is incorporated herein by this reference.

Current mobile electronic devices can provide a user with at least three types of user interfaces: a first user interface for voice use, a second user interface for handset dialing and a third user interface for entry of text. Prior solutions have attempted to address the various user interface needs for convergent mobile devices supporting voice, data and text operation. The prior art solutions are typically awkward to use, often requiring new and unintuitive methods of operation, particularly when supporting both voice and text entry operation.

It is an object of this invention to provide an improved user interface for text entry in a compact mobile electronic device.

### SUMMARY OF THE INVENTION

A hand held electronic device is provided with an improved keyboard. One embodiment of the device provides for telephonic and data communication. In this case “telephonic” should be understood to mean voice communication and “data” should be understood to mean alphanumeric, such as text, and other information which can be entered by typing as well as digital and graphical information which can be drawings, pictures, etc. One embodiment of the present device is hand held and provides a user with text messaging and voice communications. The device comprises: a display screen for displaying text and graphical information, such as icons, pictures and video, to the user. At least one speaker is provided for transmitting audio information, such as voice and music, to the user. Navigational buttons control basic functions of the device, such as on/off, initiation and termination of a telephone call, and selection and activation of icons or other data displayed on the display screen. A number pad allows the user to input numeric and text data wherein the number pad is a primary input device of telephone number data. At least one microphone is provided for receiving audio data, such as voice, from the user. Device software provides a graphical user interface for the device and controls operation of hardware provided in the device. A communication, control and memory system provides for transmission and reception of all data, voice, video, music and text from and to the device. A fold out section comprising approximately half of the portion of the device underneath the number pad unfolds in a direction perpendicular to a length of the device to reveal an extendable keyboard contained underneath the number pad. The extendable keyboard is usable with software applications on the device and provides the user with the ability to easily enter alphanumeric data and transmit the data over a wireless network. The keyboard includes keys which assist the user in typing by touch, without having to look at the keyboard.

The device can be used as a cellular telephone wherein the communication control unit includes an antenna that facilitates communication with a cellular base station. The device can also be used as a portable telephone in which case the communication control unit would include an antenna that facilitates communication with a portable telephone base that is connected, via a telephone line, to a public switched telephone network. The user can type on keys of the extendable keyboard to enter data and transmit the data from the device while a communication channel is open to a remote network. Capabilities of the device include the use of short messaging service (SMS) and similar services such as enhanced messaging service (EMS), multimedia messaging service (MMS), instant messaging (IM), picture messaging and text chat, as well as receiving and inputting data from and to the Internet via a mobile browser, and wireless data transmission applications that are compatible with SIM Application Toolkit and Wireless Application Protocol (WAP). The device can also include a small built in camera that allows pictures and short videos to be sent from the device. Predictive text software is also provided and may be used when the device is in the open and closed positions.

Another embodiment of the present device is similar to the first embodiment described above but more similar to a personal digital assistant. The device includes a keypad and a screen for displaying text and other data but does not include telephone capabilities.

The keys comprising the keyboard of the presently described embodiments are designed to facilitate typing. The keys include a plurality of keys having tactile indicia and a plurality of keys without the tactile indicia, and the keys with tactile indicia are arranged with respect to the keys without tactile indicia in special configurations. The special configurations of the tactile indicia provide a number of advantages to the user. The tactile indicia allow the user to easily type by touch alone, without looking at the keyboard. Furthermore, since the keyboard must be relatively small, the keys are small and can be obscured by the user's thumbs or fingers. Accordingly the tactile indicia permit the user to easily find all the keys even when some are obscured by his or her digits. Also, when a user becomes accustomed to the location of the tactile indicia, the user's typing speed can be enhanced.

### BRIEF DESCRIPTION OF THE DRAWINGS

The invention of the present application will now be described in more detail with reference to the accompanying drawings, given only by way of example, in which:

FIG. 1 is an isometric front view of a preferred embodiment in the closed position;

FIG. 2 is a front view of a preferred embodiment in the open position;

FIGS. 3 through 10 are details of keys of the devices shown in FIG. 2.

FIG. 11 illustrates how a user can hold one embodiment of the present invention.

FIG. 12 illustrates another embodiment of the present invention.

FIG. 13 is a schematic illustration showing how an embodiment of the present device functions as part of a wireless communication network.

### DETAILED DESCRIPTION OF THE INVENTION

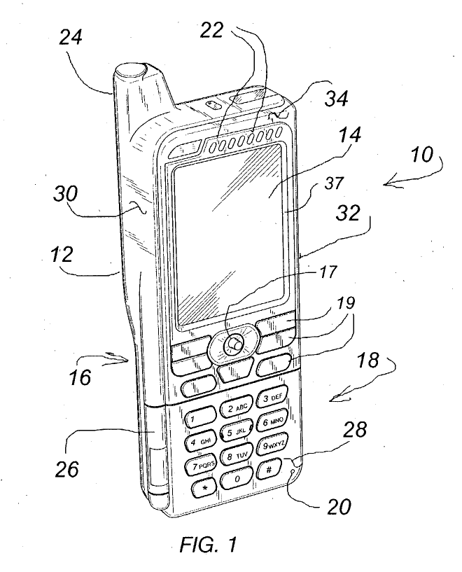

FIG. 1 shows a front view of a preferred embodiment wherein the extendable keyboard is folded closed and hidden underneath number pad 5. Electronic device 10 comprises housing 12, display 14, navigational pad 16, numeric keyboard 18, microphone 20, speaker 22, and antenna 24. The housing 12 is generally rectangular and has a left side 30, a right side 32, a front 34 and a back, which is not shown in this Figure. A hinge 26 is connected to the housing 12 and to a panel 28 comprising an extendable keyboard. The navigational pad 16 includes a joystick 17 and a plurality of navigation keys 19 which allow the user to perform certain functions on the display 14, including moving a cursor on the display. The joystick 17 and the navigation keys 19 can be considered to be pointing devices.

Display 14 provides visual output to the user. A display backlight 37 located around the periphery of the display 14 provides backlighting for use of the device at night. Display output can be text and graphics; icons, pictures, and videos. Navigational pad 16 allows the user to select options on a menu and activate various software programs, such as telephone and text communications enabling programs, which are loaded within device 10. The navigational pad 16 is configured similar to that of a conventional cellular telephone.

Numeric keyboard 18 is substantially the same as traditional cellular or wire line telephone number pad. The numbers 0-9 are typically represented on a 3×4 keypad matrix with the star symbol, zero and the # symbol residing on the bottom row of the matrix although the exact placement of these keys in this matrix fashion is not required. Alternative placements of these keys on the front surface can be accommodated. The well known standard of three, or four, letters being represented on the number pads of 0 and 2-9 are included in the numeric keyboard 18. Microphone 20 is used to accept voice data from the user. Speaker 22 provides audio output to the user, and a speakerphone may also be supported. Antenna 24 is used for radio communication between device 10 and a remote location such as a cellular telephone base station. Of course, if device 10 is used as the handset of a traditional wire line phone, then no antenna is required.

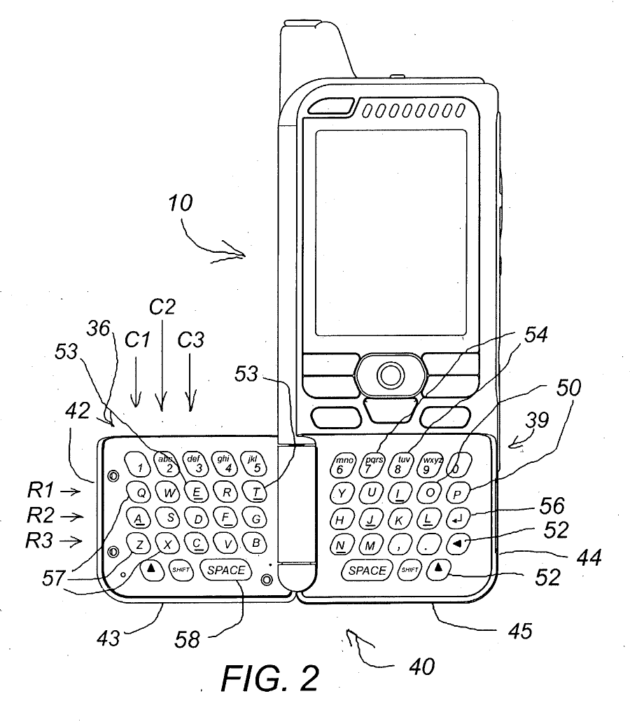

FIG. 2 shows electronic device 10 in the open position. The device 10 includes an extendable keyboard 40 which includes two sections, a left section 42 and a right section 44 which are coupled together by hinge 26. The left and right sections 42 and 44 have lower faces 43 and 45 which are in the same plane with each other when the device is in the open position. The keys 46 are translucent, and a keyboard backlight system is provided to light the keys in certain circumstances.

As shown in FIG. 2 the extendable keyboard 40 is in the open position and ready to receive keystrokes. In other words, the user has converted the device 10 from the configuration shown in FIG. 1 to the configuration shown in FIG. 2 by lifting the right side of the left section 42 so that it rotates about the hinge 26 and locks in the position shown in FIG. 2. A sensor 36 capable of sensing a magnetic field is located inside the left section 42 to sense whether the panel 28 is open or closed. A magnet 39 is located inside the right section 44 in a location which is adjacent the sensor 36 when the panel is closed. Still visible and ready for use while device 10 is in the open position are display 14, navigational pad 16, microphone 20, speaker 22, and antenna 24. The numeric keyboard 18 is not visible on the front of the device; it is on the opposite side of the folded out portion, i.e., behind the left section 42 of the keyboard 40. In this case the numeric keyboard 18 is not easily accessible to the user, but it is not necessary for it to be easily accessible since in this configuration the user uses the extendable keyboard 40 for data entry.

It should be understood that the hinge 26 could be located in other positions on the device to permit the keyboard to be folded in different ways. For example, the hinge 26 could be located on the right side of the device 10 so that the folded portion of the keyboard folds to the right side of the device rather than to the left side, as shown in FIG. 2.

The labels used on the keys are shown, and alternatively, other labeling could be used. The keyboard 40 includes a plurality of letter keys 50, control keys 52, and letter and number keys 54, all of which the user can strike to enter data. Twenty-six letter keys 50 are shown, one for each letter of the alphabet, in the configuration commonly known as a “qwerty-style” keyboard. It should be understood that other alphanumeric keys could also be used, such as keys exclusively for numbers or keys which can be used for both letters and numbers. The control keys 52 are for such typing and computer functions as space and carriage return, and other common computer-related control functions could also be assigned keys. One of the control keys, shown in this embodiment, contains the “return” key 56. This key can be used as a carriage return to break up lines of text, for a new paragraph for example, during text messaging. It may also be used as an “enter” button to select and activate a program. Another control key is the “space” key 58 that will commonly be required in text messaging. The letter and number keys 54 each provide two functions. These ten keys can act as the numbers 0-9, when a function key or icon is pressed or selected. Alternatively the letter and number keys 54 can be used to type letters in a mode similar to the operation of the numeric keyboard 18.

It should be noted that the keys are designed to facilitate typing on the relatively small keyboard of the present device 10. The keys are arranged in two sections, a top section comprising the letter and number keys 54 and a bottom section comprising control keys 52 and letter keys 50. The keys include a plurality of keys 53 having tactile indicia and a plurality of keys 57 without the tactile indicia, and the keys 53 with tactile indicia are arranged with respect to the keys 57 without tactile indicia in special configurations.

As shown in FIG. 2, the keys 53 with tactile indicia represent the letters E, T, I, A, F, J, L, C, and N. The layout of the letter keys 50 of the keyboard is according to the standard QWERTY format comprising three rows, R1, R2 and R3, and 10 columns, C1-C10. (For the purpose of clarity, only columns C1-C3 are labeled in FIG. 2.) The letter keys which are not tactile indicator keys 53 are called “standard” keys 57. It can be seen that the tactile indicator keys 53 are located so that at least one tactile indicator key 53 is located adjacent each standard key 57. For example, tactile indicator key E is adjacent standard keys W, S, D, and R, it being understood that “adjacent” as used herein means adjacent in the horizontal, vertical or diagonal direction. Also, “adjacent” means that there is no key between two keys which are “adjacent” to one another.

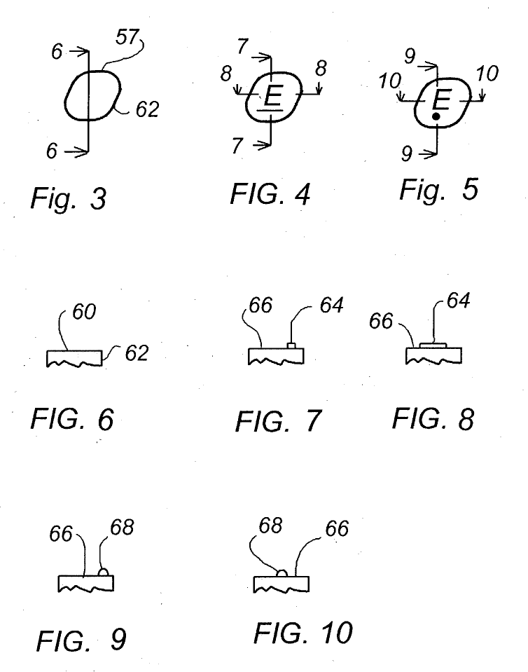

Turning now to FIGS. 3-10, the configuration of the keys is shown. FIG. 3 shows the top 60 of a standard key 57, and FIG. 6 is a cross section of the key 57 which shows that the top 60 of the key 57 is flat, and the sides 62 are flat. FIG. 4 shows a preferred embodiment for a tactile indicator key 53, in this case the E key, which includes tactile indicia in the form of a raised bar 64 located below the label E on the top 66 of the key. FIGS. 9 and 10 show the top of the E key in cross section. FIG. 5 shows an alternative embodiment of the E key wherein the tactile indicator is a dome shaped piece 68 located below the E label on the top of the key. It should be understood that these illustrated designs of the standard key 57 and tactile indicator key 53 are merely examples, and many other designs are possible within the scope of the invention. For example, standard keys 57 can be configured like many of the different forms of keys which are presently well known in existing keyboard designs. Also, tactile indicator keys 57 can be configured in many different ways. The important point is that the standard keys 57 and the tactile indicator keys 53 are configured so that a user can easily distinguish between the two types of keys by touch. Furthermore, it is not necessary that all of the standard keys 53 are identical to one another, and likewise it is not necessary that all of the tactile indicator keys 53 are identical to one another. For example, the tactile indicator keys E and A can be of one configuration while the tactile indicator keys T, F, and C can be of a different configuration. The important point is that both types of keys are configured so that a user can easily determine by touch where his or her digits are on the keyboard.

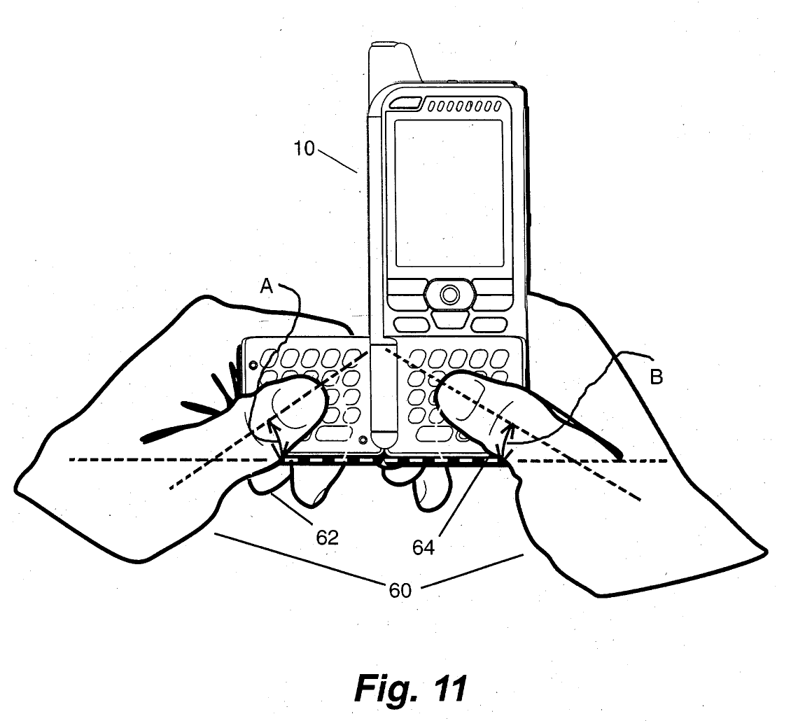

Turning now to FIG. 11, the Figure shows the device 10 in use as one frequently holds the device. It can be seen that the user grasps the right side of device 10 with the right hand and the left section 42 with the left hand and strikes the keys with the tips of the thumbs 72 and 74. It should be noted that the user's hands 60 are oriented so that left and right thumbs 62 and 64, respectively, have their axes oriented about 30 degrees from the lower faces 43 and 45 of the left and right sections 42 and 44, respectively. The angles are shown as A and B, which are measured from the dashed lines wherein two dashed lines show the axes of the thumbs and the horizontal dashed line is coincident with the lower face of the device.

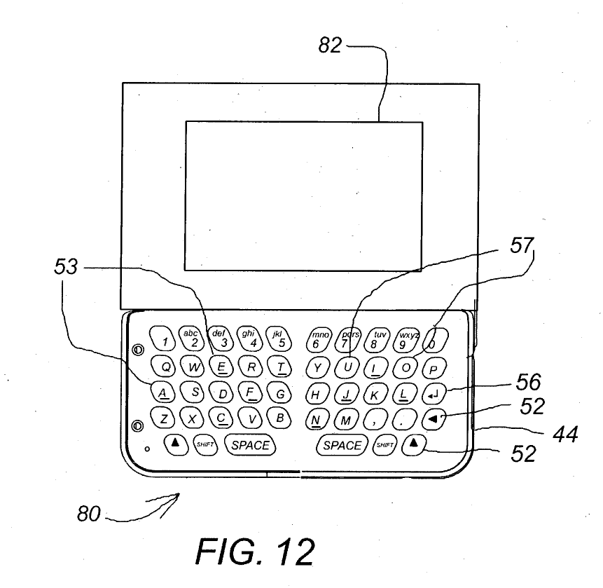

Turning now to FIG. 12, another embodiment is illustrated. This embodiment is similar to the design of a standard personal digital assistant (PDA) which is well known in the art. The device includes a keyboard 80 with a display 82 connected above it. The standard keys 57 and tactile indicator keys 53 comprising the keyboard 80 are the same as the keys described above in connection with FIGS. 1-11.

It should be recognized that the keys 53 and 57 are specifically designed to facilitate typing. The extendable keyboard is considerably smaller than a desk top computer keyboard; specifically, the extendable keyboard 40 is about 1.62 inches by about 3.78 inches. Therefore each key must be significantly smaller than a key of a computer keyboard. Of course, as keys are made smaller they can become difficult for a user to easily and correctly strike.

The special configuration of the tactile indicia keys provide a number of advantages to the user. The tactile indicia keys 53 allow the user to easily type by touch alone, without looking at the keyboard. Furthermore, since the keyboard must be relatively small, the keys are small and can be obscured by the user's thumbs or fingers. Accordingly the tactile indicia permit the user to easily find all the keys even when some are obscured by his or her digits. Also, when a user becomes accustomed to the location of the tactile indicia, the user's typing speed can be enhanced.

The present device is intended to ease the typing burden on users that take advantage of cost efficient messaging services such as SMS. The Short Message Service (SMS) is the ability to send and receive text messages to and from mobile telephones. The text can comprise of words or numbers or an alphanumeric combination. SMS was created as part of the GSM Phase 1 standard. Each short message is up to 160 characters in length when Latin alphabets are used, and 70 characters in length when non-Latin alphabets such as Arabic and Chinese are used.

In operation, a network operator launches SMS Mobile Originate, software executed at base stations, to give customer true two-way SMS capability. Customers experiment with the service and work out new uses for it. Addition of a wireless Internet/mobile email service often follows, typically with the customer's mobile number becoming part of the email address they are allocated as part of the service. Emails sent to that address are forwarded as a short message to their wireless phone. Such a service tends to be popular with customers that don't already have an email address. Other information services are available. These services typically start with mainstream content such as news, travel, weather and sports.

The introduction of standardized protocols such as SIM Application Toolkit and the Wireless Application Protocol (WAP) have contributed to an increase in messaging usage by providing a standard service development and deployment environment for application developers and business partners. These protocols also make it easier for users to reply to and otherwise access messaging services through the provision of custom menus on the phone. The introduction of more friendly and easy to use terminals, such as device 10, will contribute to increases in messaging usage by providing simpler access to messaging services.

Mobile phone users sometimes prefer to communicate with each other using the Short Message Service. Typically, such person to person messaging is used to say hello or prompt someone for information or arrange a meeting or pass on some information. Such messages are usually originated from the mobile phone keypad. When the information to be communicated is short or it would take too long to have a full conversation or someone is traveling overseas or not available to take a voice call, SMS is an ideal messaging medium. For example, network operators typically charge the same to send a short message to someone in the same room as they do to someone traveling overseas with their mobile phone.

Because short messages are proactively delivered to mobile phones that are typically kept in the user's pocket and can be stored for later reference, SMS is often more convenient than email to communicate amongst distributed and mobile groups of people. Once users have familiarized themselves with reading and sending short messages, they often find that SMS is a useful way of exchanging information and keeping in touch with friends. This is particularly so when the recipient is also able to reply to messages for two-way communication. Simple person to person messaging generates a high volume of short messages. The most common use of SMS is for notifying mobile phone users that they have new voice or fax mail messages waiting. This is therefore the starting point for most mobile network operators and the first time that mobile phone users use SMS.

Whenever a new message is dispatched into the mailbox, an alert by SMS informs the user of this fact. Because SMS is already routinely used to alert users of new voice mail messages, this application may become one of the largest generators of short messages. Unified messaging is an emerging value-added network service that is particularly compelling because it elevates communication above the technology used to communicate; the message takes precedence over the media. The traditional message collection method is difficult to manage considering all of the different kinds of messages that people get; users have to log-on and pick up emails, pick up their faxes from the fax machine, call in and listen to voice mail and so on. Unified messaging involves providing a single interface for people to access the various different kinds of messaging they use such as fax, voice mail, short messages, and email. Now all of these types of messages can be conveniently accessed from a single point in the most actionable form. The user typically receives a short message notifying them that they have a new message in their unified messaging box. The short message often also includes an indication of the type of new message that has been deposited, such as fax, email or voice mail.

Unified messaging is a convenient application that is likely to become mainstream in the future. It should therefore be a significant generator of short messages as more services are launched. Upon receiving a new email in their mailbox, most Internet email users do not get notified of this fact. They have to dial in speculatively and periodically to check their mailbox contents. However, by linking Internet email with SMS, users can be notified whenever a new email is received. The Internet email alert is provided in the form of a short message that typically details the sender of the email, the subject field and first few words of the email message. Most of the mobile Internet email solutions incorporate filtering, such that users are only notified of certain messages with user-defined keywords in the subject field or from certain senders. Users could find it expensive or inconvenient to be alerted about every email they receive (including unsolicited “spam” emails), which would reduce the value of the service. Because of the high and increasing usage of Internet email to communicate globally, and the benefit from using SMS to notify mobile users about important new email messages, this is likely to be a fast growing and popular application for SMS.

Another emerging SMS-based application is downloading ringtones. Ringtones are the tunes that the phone plays when someone calls it With the same phone often sold with the same default tune, it is important for phone users to be able to change their ringtone to distinguish it from others. Phones often come with a range of different ringtones built into the phone's memory that the users can choose from. However, it has become popular to download new ringtones from an Internet site to the phone—these phones tend to be popular television or film theme tunes. Ringtone composers are also popular because they allow mobile phone users to compose their own unique ringtones and download them to their phones.

The Short Message Service can be used to deliver a wide range of information to mobile phone users from share prices, sports scores, weather, flight information, news headlines, lottery results, jokes to horoscopes. Essentially, any information that fits into a short message can be delivered by SMS. Information services can therefore be configured as push-based and from a public or private source or pull-based and from a public or private source. An information service for an affinity program may combine public information such as share prices with private information from bank databases. Successful information services should be simple to use, timely, personalized and localized.

Electronic commerce applications involve using an electrical device such as a mobile phone for financial transaction purposes. This usually means making a payment for goods or transferring funds electronically. Transferring money between accounts and paying for purchases are extremely popular electronic commerce applications. The convenience of paying for purchases using SMS must be weighed against the related issues of security, integration with the retail and banking hardware and systems, and money transfer issues. However, this area of electronic commerce applications is expected to contribute significantly to the growing amount of SMS traffic. The cellular telephone embodiment of the present device is tailored toward taking advantage of all of the above features of SMS by providing an extendable keyboard for text entry.

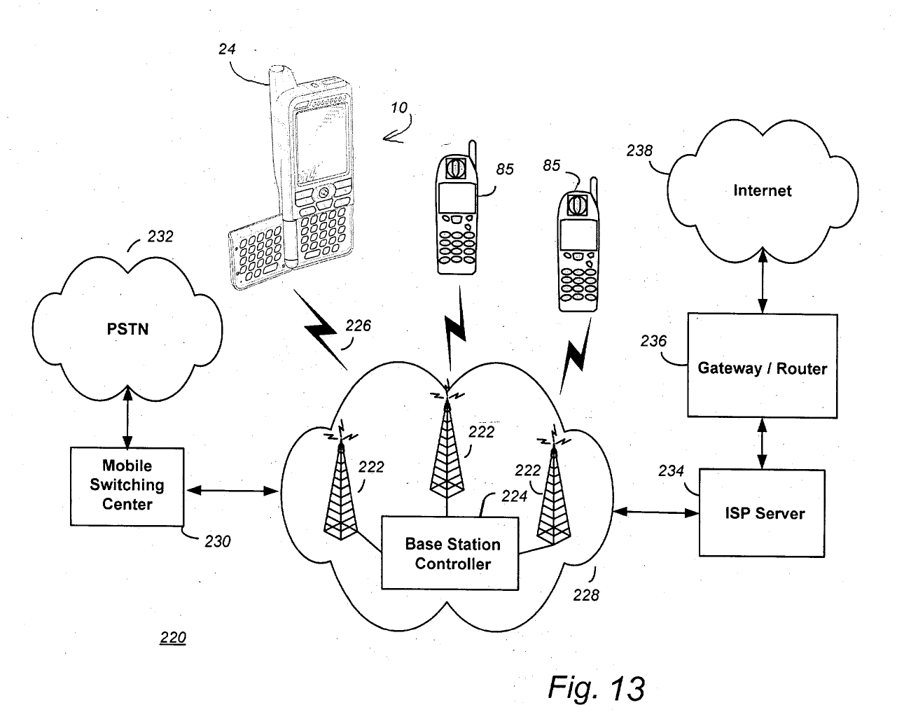

FIG. 13 illustrates how device 10 may be configured in a wireless communications system 220 to communicate both voice and data to a remote electronic device. According to embodiments of the present invention, a user may utilize the extendable keyboard 40 of device 10 to send data over the Internet to a remote device or directly to a hand-held electronic device over a network 228. Antenna 24 of device 10 transmits and receives RF signals modulated by data and voice information to and from one of base stations 222 over a wireless link 226 to wireless network 228. Base station controller 81 transmits and receives voice modulated signals to and from a mobile switching center 224, which communicates with a remote device (e.g. a telephone) over the PSTN (Public Switched Telephone Network) 232. Base station controller 224 also transmits and receives data modulated signals to and from an ISP (Internet Service Provider) Server 234. ISP server 234 transmits and receives data to and from a gateway/router 236, which sends and receives the data to and from a remote device over the Internet 238 using, for example, Session Initiated Protocol (SIP). Data entered from keyboard 40 of device 10 may also be transmitted by antenna 24, over wireless network 228, to a remote hand-held electronic device 85 using the SMS, SIM, WAP protocols, or the like. Wireless network 228 may comprise any circuit-switched network, any connectionless packet-switched signaling network, any two-way paging network, and may support cellular technologies such as, for example, PCS, GSM (global System for Global Communication), GPRS (General Packet Radio Service), CDMA (Code Division Multiple Access), TDMA (Time Division Multiple Access), or W-CDMA (Wideband Code Division Multiple Access). The communication, control and memory means 204 of the present device can establish a connection through a communication channel using circuit switched or packet switched means or other, similar means. It should be understood that the wireless network 228 can include short range wireless technologies such as Bluetooth or others which include wireless lan 802.11b, 802.11a, 802.11g, infrared, and ultrawideband.

The foregoing description of the specific embodiments will so fully reveal the general nature of the invention that others can, by applying current knowledge, readily modify and/or adapt for various applications such specific embodiments without departing from the generic concept. For instance, the display screen could be made larger to dominate the front of the device and/or a pointing device could be incorporated to aid data input. Also, it would be possible to incorporate alternative or additional hinge systems so that e.g. the display screen could fold over or under the keyboard. Therefore, such adaptations and modifications should and are intended to be comprehended within the meaning and range of equivalents of the disclosed embodiments. It is to be understood that the phraseology of terminology employed herein is for the purpose of description and not of limitation. Also, it should be understood that although SMS has been discussed extensively, capabilities of the device also include similar services such as enhanced messaging service (EMS), multimedia messaging service (MMS), instant messaging (IM), picture messaging and text chat, as well as receiving and inputting data from and to the Internet.

We claim:

1. A mobile electronic communication device comprising:
a housing;
a display coupled to said housing; and,
a keyboard coupled to said housing, said keyboard comprising a plurality of keys,
wherein said plurality of keys comprise a plurality of tactile indicator keys and a plurality of standard keys, and at least one tactile indicator key is located adjacent each standard key.

2. A device according to claim 1 wherein at least four standard keys are surrounded by six keys and at least two of said six keys are tactile indicator keys.

3. A device according to claim 1 wherein said plurality of keys are arranged in at least three rows, and at least one key in each row is a tactile indicator key.

4. A device according to claim 3 wherein at least three keys in each row are tactile indicator keys.

5. A device according to claim 3 wherein said keys are arranged in at least six columns and at least two tactile indicator keys are located in at least one column.

6. A device according to claim 1 wherein each said tactile indicator key includes a bump on the face of said key.

7. A keyboard for use with a mobile electronic communication device, said keyboard comprising:
a plurality of tactile indicator keys; and,
a plurality of standard keys;
wherein said keys are arranged so that when a user has the user's thumb placed on a tactile indicator key the user can move the thumb to a standard key without moving the thumb a distance greater than the width of two standard keys.

8. A keyboard for typing the letters of the alphabet, said keyboard comprising at least a plurality of keys of a first configuration and a plurality of keys of a second configuration, at least one key of said first configuration being located adjacent each key of said second configuration.
